(19) United States
(12) Patent Application Publication
(10) Pub. No.: US 2004/0112704 A1
(43) Pub. Date: Jun. 17, 2004

(54) Synchronous drive coupling

(76) Inventors: Wulf McNeill, Kenosha County, WI (US); Ernest Infusino, Kenosha County, WI (US)

Correspondence Address: JANSSON, SHUPE & MUNGER, LTD, 245 MAIN STREET, RACINE, WI, 53403, US

(21) Appl. No.: 10/653,378

(22) Filed: Sep. 2, 2003

Related U.S. Application Data
(60) Provisional application No. 60/407,113, filed on Aug. 30, 2002.

(51) Int. Cl. F16D 11/00

(52) U.S. Cl. 192/53.1

(57) ABSTRACT

This invention involves a transmission-input assembly for direct drive engagement with a disk which is driven rotationally around a disk axis. The invention involves bringing rotating components into near synchronous angular velocity through frictional engagement before bringing the components into mechanical engagement to allow for direct drive through mechanically coupled rotation.

### FIELD OF THE INVENTION

This invention is related generally to mating two rotating bodies and more particularly to synchronizing the angular speeds of two rotating bodies prior to mating.

### BACKGROUND OF THE INVENTION

Currently, most semi-tractors and heavy industrial machinery utilize a friction plate style clutch. In such system, the motor drives a disk-like flywheel. The outer surface of the flywheel is covered with a gritty mix designed to greatly increase the coefficients of sliding and static friction on that surface. When disengaged, a coaxial clutch plate is kept out of contact with the flywheel.

To disengage the clutch, a throw-out bearing forces the clutch plate out of frictional engagement with the rotating flywheel. As the respective disks make contact with each other, there is a tendency for the clutch plate to slip as the clutch plate is under load with the drive shaft and the flywheel is initially unlugged. At contact, the frictional engagement causes a relative angular velocity difference between the flywheel and the clutch plate to decrease as the clutch plate is accelerated up to a synchronous speed with the flywheel. At the same time, the flywheel is angularly decelerated as it is put under load from the clutch/drive shaft combination. The engine causes the flywheel to accelerate to reach operating speeds. Through frictional engagement, the drive shaft is accelerated and it remains at operating speed only through the frictional interface between the flywheel and the clutch plate.

At high speeds, under heavy load or going up inclines, there is a tendency for the frictional engagement to slip causing de-synchronicity and the unit popping out of gear.

Moreover, when first placed into contact, and when slipping under lug, there is a tendency for the frictional coating to erode. Currently the frictional pads are created of a stone base such as an asbestos which causes heavy dust and dirty conditions.

Further, due to the heavy lugging, the current system is extraordinarily heavy necessitating at least two mechanics to change out a worn clutch plate.

Due to the operating methods, the clutch plates tend to wear quickly, are heavy and cumbersome to change, can slip under heavy load or at high speed, are dirty, and expensive to produce.

There is a need in the industry to create a synchronous couple that is longer lasting, lighter weight, cheaper to produce, and easier for one person to replace.

### OBJECTS OF THE INVENTION

It is an object of this invention to present a synchronous couple transferring torque produced by an engine to the drive wheels which is lighter in weight than existing clutches.

It is another object of this invention to provide a synchronous couple between the engine and the drive wheels that has fewer moving parts than standard clutches.

It is yet another object of the invention to provide a synchronous system that minimizes driver interaction with functional operation of the unit.

Another object of the invention is to provide a synchronous couple with no clutch brake.

Still another object of the invention is to provide a synchronous couple between a flywheel of an engine and drive wheels that minimizes slippage, especially slippage at high speeds or under heavy loads.

Still another object of the invention is to provide a synchronous couple that is easy to install and remove.

Yet another object of the invention is to provide a synchronous couple that is not reliant on the co-efficient of friction between the flywheel and the clutch plate.

Still yet another object of the invention is to provide a synchronous couple interface with an engine flywheel that is less susceptible to wear due to its non-reliance on the frictional engagement between the flywheel and the clutch plate when the combination is operating under load.

It is yet another object of the invention to provide a synchronous couple between the flywheel of an engine and the drive train which makes wear more evident upon visual inspection.

These and other important objects will be apparent from the following descriptions of this invention which follow.

### SUMMARY OF THE INVENTION

This invention involves a transmission-input assembly for direct drive engagement with a disk which is driven rotationally around a disk axis. The disk, which could be a flywheel, has a substantially flat, radial disk surface with a central, shaft-receiving aperture. By the term “flat” Applicants mean a continuous surface, Applicants specifically include within this definition conic surfaces which are constant. The transmission-input assembly consists of an elongated input shaft and a synchronous couple. The elongated input shaft has a shaft axis coaxial with the disk axis and has a first end rotatably held in the shaft-receiving aperture (e.g., the pilot bearing). The synchronous couple has (a) a frictional-engagement member axially, slideably attached with respect to the shaft and radially interlocked with the shaft whereby the shaft and the frictional-engagement member rotate about the shaft axis as a unit, further having a frictional surface configured and arranged to engage the disk surface, whereby slippage between the frictional surface and the disk surface is minimized, thereby producing rotation of the frictional engagement member and the shaft about the shaft axis; (b) a mechanical-engagement member axially, slideably attached with respect to the shaft and radially interlocked with the shaft whereby the shaft and the mechanical-engagement member rotate about the shaft axis as a unit further having at least one mating element to matingly engage at least one complementary mating-element-engaging element on the disk whereby mechanical engagement occurs between the mechanical-engagement member and the disk thereby producing rotation of the mechanical-engagement member and shaft about the shaft axis; (c) at least one pressure-producing member attached with respect to the frictional engagement member whereby pressure may be applied by the pressure-producing member to the frictional engagement member in order to urge the frictional engagement member along the shaft axis into frictional engagement with disk; (d) a selector for at least one actuator to engage and disengage the at least one first pressure-producing member in response to a stimulus; and (e) a synchronous engagement element to axially urge the mechanical-engagement member into mechanical engagement with the disk when the shaft and the disk have a same angular velocity. Before frictional engagement, the disk has a first angular velocity and the shaft has a second angular velocity. After frictional engagement, the second angular velocity is changed to nearly match the first angular velocity, at which point of synchronicity, mechanical engagement occurs between the mechanical-engagement member and the disk to allow for direct drive through mechanically coupled rotation.

It is preferable when within the assembly, the mating element further comprises a hub extending axially out from the radial disk surface, with longitudinal hub splines, and the mating-element-engaging element further comprises a collar extending axially out from the mechanical-engagement member, with longitudinal collar splines complementary to the hub splines of the disk, whereby the mechanical engagement between the mechanical-engagement member and the disk occurs through interlocking of the longitudinal collar splines and the longitudinal hub splines. It is more preferable for the longitudinal hub splines and the longitudinal collar splines to be helical.

In one preferable version, the helical splines spiral from the mechanical-engagement member to the disk in the same direction of rotation of the disk whereby when the disk is under rotation about the axis, the mechanical-engagement member and the disk will tend to decouple due to centrifugal effect.

When the helical splines spiral from the mechanical-engagement member to the disk in the same direction of rotation of the disk, it is even more preferable when the synchronous engagement element has a plurality of elongated pins, a top cap, and a resilient member. The plurality of elongated pins is of a certain number attached with respect to the frictional-engagement member. Each pin has a proximal end of a first diameter attached with respect to the frictional-engagement member, thence extending distally therefrom, parallel to the axis, and a distal end of a second diameter. The second diameter is less than the first diameter with a taper from the distal end to the proximal end, and the distal end terminates in a stop of a third diameter greater than the second diameter. The top cap is attached with respect to the mechanical-engagement portion, and encircles but not fixedly engages the shaft. The top cap defines a series of oblong apertures at least equal in number to said pins. Each aperture has a bulbous portion dimensioned larger than the first diameter but less than the third diameter and a narrow portion dimensioned greater than the second diameter but less than the first diameter. The bulbous end of each aperture trails the narrow end when the frictional-engagement portion is in rotational motion. The resilient member is within the bulbous end of the aperture and in contact with the at least one pin with a restoring force directed toward the narrow end. In this way, a pin not under other pressure will be driven relative to the top cap by the restoring force to a position in the narrow portion of the aperture. When the couple is not rotating and the pressure-producing member is not applying pressure to the frictional-engagement member, the pin extends through the narrow portion of the aperture with the stop distal to the top cap and the taper is within the aperture, and when the frictional-engagement member is under pressure from the pressure-producing member thereby placing the shaft under rotation by engagement of the frictional-engagement member with the disk but the mechanical-engagement member is not engaged, the top cap will rotate with the couple whereby the tapered portion of the pin is forced into the narrow portion of the aperture and further thereby preventing axial movement of the top cap. When the first angular velocity is exceeded by the second angular velocity, the pins will experience the restoring force and a rotational shear force due to the different angular velocity, said restoring and rotational shear forces will push the pins toward the bulbous end. During the push, the axial force of the pressure-producing member will urge the mechanical-engagement member into synchronous couple. It is further preferable to provide an axial spring between the disk and the couple.

When the helical splines spiral from the mechanical-engagement member to the disk in the same direction of rotation of the disk, it is also preferable when the synchronous engagement element is:

a plurality of elongated pins of a certain number attached with respect to the frictional-engagement member, each pin having a proximal end of a first diameter attached with respect to the frictional-engagement member, thence extending distally therefrom, parallel to the axis, and a distal end of a second diameter, said second diameter less than the first diameter with a taper from the distal end to the proximal end, and said distal end terminating in a stop of a third diameter greater than the second diameter; and

a top cap attached with respect to the mechanical-engagement portion, and encircling but not fixedly engaging the shaft, said top cap defining a series of oblong apertures at least equal in number to said pins, each aperture having a bulbous portion dimensioned larger than the first diameter but less than the third diameter and a narrow portion dimensioned greater than the second diameter but less than the first diameter, said bulbous end of each aperture trailing the narrow end when the frictional-engagement portion is in rotational motion; and

a resilient member within the bulbous end of the aperture and in contact with the at least one pin with a restoring force directed toward the narrow end, whereby a pin not under other pressure will be driven relative to the top cap by the restoring force to a position in the narrow portion of the aperture;

whereby when the couple is not rotating and the pressure-producing member is not applying pressure to the frictional-engagement member, the pin extends through the narrow portion of the aperture with the stop distal to the top cap and the taper is within the aperture, and whereby when the frictional-engagement member is under pressure from the pressure-producing member thereby placing the shaft under rotation by engagement of the frictional-engagement member with the disk but the mechanical-engagement member is not engaged, the top cap will rotate with the couple whereby the tapered portion of the pin is forced into the narrow portion of the aperture and further thereby preventing axial movement of the top cap; and whereby when the first angular velocity equals the second angular velocity, the pins will experience no other angular force other than the restoring force and hence will be pushed towards the bulbous end and the axial force of the pressure producing member will urge the mechanical-engagement member into synchronous couple.

It is also a preferable embodiment wherein the at least one pressure-producing member is at least one hydraulic bladder. It is more preferable where the at least one hydraulic bladder is further comprised of a first hydraulic bladder and a second hydraulic bladder. The first hydraulic bladder is actuated by a first actuator and attached with respect to the frictional engagement member whereby the first hydraulic bladder when actuated applies pressure to the frictional-engagement member thereby urging the frictional-engagement member into frictional engagement with the disk. The second hydraulic bladder is actuated by a second actuator and attached with respect to the mechanical-engagement member whereby the second hydraulic bladder when actuated applies pressure to the mechanical-engagement member thereby urging the mechanical-engagement member into mechanical engagement with the disk.

It is more preferable when using the bladders for the helical splines to spiral in the same direction of rotation of the disk whereby when the disk is under rotation about the axis, the mechanical-engagement member and the disk will tend to decouple due to centripetal force.

When using at least one bladder, it is preferable to supply an axial spring located between the disk and the couple.

It is a preferable version of this first aspect of the invention when the disk has a mechanical-engagement surface, said mechanical-engagement surface having disk-surface discontinuities, and the mechanical-engagement member has a disk-engagement surface having mechanical-engagement-member-surface discontinuities which are complementary to the disk-surface discontinuities, whereby the mechanical engagement between the mechanical-engagement member and the disk occurs through interlocking of the disk-surface discontinuities and mechanical-engagement-member-surface discontinuities.

Another aspect of this invention is a method for decoupling a rotationally driven member which is axially mechanically coupled to a driving member which is rotating about an axis. The method comprises the steps of (a) providing a cylindrical driving hub having a proximal end and a distal end, (b) providing a driven member having a cylindrical driven hub, (c) providing an axial pressure member attached with respect to the driven member, (d) providing a switch to selectively engage or disengage the pressure-producing member, and (e) disengaging the pressure-producing member. The cylindrical driving hub has a proximal end attached to the driving member such that the hub is coaxial with the axis of rotation of the driving member, a distal end, and helical, longitudinally-extending hub splines. The hub splines spiral with respect to the cylinder from the proximal end of the driving hub to the distal end of the driving hub in a circular direction opposite the direction of rotation of the driving member. The driven member has a cylindrical, driven hub with a proximal end and a distal end. The distal end is attached with respect to the driven member and has longitudinally-extending helical splines. The splines are complimentary in shape and spiral to the driving hub splines in order that the driving hub splines may interact the driven hub splines producing rotational motion in the driven member. The axial pressure member is attached with respect to the driven member whereby the axial pressure from the pressure-providing member will urge the driven-member hub splines into mechanical engagement with the driving-member hub splines. The centrifugal effect produced by the rotation of the driving member will tend to force the respective splines of the driving hub and driven hub into disengagement.

Yet another aspect of this invention is a method for producing mechanical synchronous coupling of a rotating driving member having a mechanical-engagement receiving member to a rotating driven member having a frictional-engagement member in frictional contact with the rotating driving member. The driving member and the driven member rotating about a common axis. The method consists of the steps (a) providing a mechanical-engagement member, (b) applying axial pressure to the mechanical-engagement member, (c) providing a synchronizer, and (d) creating the positive rotational inertial difference between the driving member and the driven member. The mechanical-engagement member provided is rotatably and axially slidably attached with respect to the frictional-engagement member. The axial pressure is applied to the mechanical-engagement member through a pressure-producing member configured and arranged to apply axial pressure in the direction of engagement with the driving member. The synchronizer is in contact with the mechanical-engagement member. The synchronizer has a support member attached with respect to the driving member, defining at least one channel, at least one pilot member attached with respect to the mechanical-engagement member, configured and arranged to freely travel along the channel and thereby allow axial travel of the mechanical-engagement member toward engagement with the mechanical-engagement receiving member, a switchable gate-keeping member in contact with the pilot member, preventing free movement of the pilot member within the at least one channel when in an enabled mode, and an inertial switch to disable the gate-keeping member when a positive inertial difference exists between the driving member and the driven member.

The positive rotational inertial difference is created between the driving member and the driven member in frictional contact with the driving member by angularly decelerating the driving member after the driven member has been accelerated to near synchronous angular velocity with the driving member. In this way, the mechanical coupling is allowed between the driving member and the driven member when the inertial difference is obtained.

It is preferable for the at least one pilot member to be at least one elongated pin of a certain number, each of the at least one pin having a proximal end of a first diameter attached with respect to the frictional-engagement member, thence extending distally therefrom, parallel to the axis, and a distal end of a second diameter, said second diameter less than the first diameter with a taper from the distal end to the proximal end. The distal end terminates in a stop of a third diameter greater than the second diameter. The support member is a top cap attached with respect to the mechanical-engagement portion, and encircling but not fixedly engaging a shaft attached to and coaxial with the driven member. The top cap has a series of oblong apertures. Each aperture serves as a channel. There are at least as many apertures as pins. Each aperture has a bulbous portion dimensioned larger than the first diameter but less than the third diameter and a narrow portion serving as a gate-keeping member, dimensioned greater than the second diameter but less than the first diameter. The bulbous end of each aperture leads the narrow end when the frictional-engagement portion is in rotational motion. The inertial switch is a resilient member within the bulbous end of the aperture and in contact with the at least one pin with a restoring force directed toward the narrow end. The at least one pin when not under other pressure will be driven relative to the top cap by the restoring force to a position in the narrow portion of the aperture.

It is preferable for the resilient member to be a metal spring. It is preferable for the pressure-producing member to be a hydraulic bladder actuated by an actuator.

Another aspect of this invention is a method for selectively coupling and decoupling of a transmission-input assembly for direct drive engagement with a disk, which is driven rotationally around a disk axis. The disk has a substantially flat, radial disk surface with a central, shaft-receiving aperture. The method consists of the steps of (a) providing the transmission-input assembly, (b) accelerating the disk, (c) applying an engaging stimulus to the selector to engage the pressure-producing member and urge the friction-engagement member into frictional engagement with the rotating disk, (d) producing an inertial difference between the disk and the shaft, and (e) providing a disengaging stimulus to the selector to disengage the pressure-producing member. The transmission-input assembly has an elongated input shaft with a shaft axis coaxial with the disk axis and with a first end rotatably held in the shaft-receiving aperture; a synchronous couple; and a decoupler. The synchronous couple has a frictional-engagement member axially, slidably attached with respect to the shaft and radially interlocked with the shaft whereby the shaft and the frictional-engagement member rotate about the shaft axis as a unit, further having a frictional surface configured and arranged to engage the disk surface, whereby slippage between the frictional surface and the disk surface is minimized, thereby producing rotation of the frictional engagement member and the shaft about the shaft axis; a mechanical-engagement member axially, slidably attached with respect to the shaft and radially interlocked with the shaft whereby the shaft and the mechanical-engagement member rotate about the shaft axis as a unit further having at least one mating element to matingly engage at least one complementary mating-element-engaging element on the disk whereby mechanical engagement occurs between the mechanical-engagement member and the disk thereby producing rotation of the mechanical-engagement member and shaft about the shaft axis; at least one pressure-producing member attached with respect to the frictional engagement member whereby pressure of a first value may be applied by the pressure-producing member to the frictional engagement member in order to urge the frictional engagement member along the shaft axis into frictional engagement with disk; a selector for at least one actuator to engage and disengage the at least one first pressure-producing member in response to a stimulus; a synchronous engagement element to axially urge the mechanical-engagement member into mechanical engagement with the disk when the shaft and the disk have a same angular velocity; a releasable gate to selectively prevent axial motion of the mechanical-engagement member; and an inertial switch triggered by the application of a torque applied by the mechanical-engagement member to release the gate thereby allowing axial motion of the mechanical-engagement member. The decoupler is attached with respect to the disk providing pressure along the shaft of a second value less than the pressure of the first value exerted by the pressure-producing member, but of a sufficient pressure to eject the synchronous couple from mechanical and frictional engagement with the disk when the pressure-producing member is disengaged. The engaging stimulus is applied to the selector to engage the pressure-producing member and urge the friction-engagement member into frictional engagement with the rotating disk, thereby accelerating the shaft. When the inertial difference is created between the disk and the shaft, the inertial switch is thrown because of the relative torque due to the inertial difference. The mechanical-engagement member is released to be urged axially by the pressure from the pressure-producing member, into mechanical engagement with the disk to allow for direct drive through mechanically coupled rotation. The disengaging stimulus is provided to the selector to disengage the pressure-producing member, thereby allowing the decoupler to decouple the synchronous couple from engagement with the disk.

It is preferable for the mating element to further comprise a hub extending axially out from the radial disk surface, with longitudinal hub splines. The mating-element-engaging element further comprises a collar extending axially out from the mechanical-engagement member, with longitudinal collar splines complementary to the hub splines of the disk, whereby the mechanical engagement between the mechanical-engagement member and the disk occurs through interlocking of the longitudinal collar splines and the longitudinal hub splines. It is yet more preferable for the longitudinal hub splines and the longitudinal collar splines to be helical. It is even yet more preferable in this version of the aspect of the invention for the decoupler to have helical splines which spiral from the mechanical-engagement member to the disk in the same direction of rotation of the disk. In this way, when the disk is under rotation about the axis without axial pressure being applied with respect to the mechanical-engagement member, centrifugal effect will tend to decouple the mechanical-engagement member and the disk.

It is yet still more preferred in this version when the synchronous engagement element is a plurality of elongated pins of a certain number, each pin having a proximal end of a first diameter attached with respect to the frictional-engagement member, thence extending distally therefrom, parallel to the axis, and a distal end of a second diameter, said second diameter less than the first diameter with a taper from the distal end to the proximal end, and said distal end terminating in a stop of a third diameter greater than the second diameter; and there is a top cap attached with respect to the mechanical-engagement portion, and encircling but not fixedly engaging the shaft. The top cap has a series of oblong apertures at least equal in number to said pins. Each aperture has a bulbous portion dimensioned larger than the first diameter but less than the third diameter and a narrow portion dimensioned greater than the second diameter but less than the first diameter, said bulbous end of each aperture leading the narrow end when the frictional-engagement portion is in rotational motion. There is a resilient member within the bulbous end of the aperture and in contact with the at least one pin with a restoring force directed toward the narrow end, whereby a pin not under other pressure will be driven relative to the top cap by the restoring force to a position in the narrow portion of the aperture. In this manner, when the couple is not rotating and the pressure-producing member is not applying pressure to the frictional-engagement member, the pin extends through the narrow portion of the aperture with the stop distal to the top cap and the taper is within the aperture. Further, when the frictional-engagement member is under pressure from the pressure-producing member, the shaft is placed under rotation by engagement of the frictional-engagement member with the disk but the mechanical-engagement member is not engaged, the top cap will rotate with the couple thereby forcing the tapered portion of the pin into the narrow portion of the aperture and further thereby preventing axial movement of the top cap. Further still, when the first angular velocity is exceeded by the second angular velocity, the pins will experience no other angular force other than the restoring force and hence will be pushed into the bulbous end and the axial force of the pressure producing member will urge the mechanical-engagement member into synchronous couple.

It is even still yet more preferable for an axial spring to be located between the disk and the couple.

It is a preferable version of this aspect of the invention for the at least one pressure-producing member to be at least one hydraulic bladder. It is more preferable in this version where the at least one hydraulic bladder is further comprised of a first hydraulic bladder and a second hydraulic bladder. The first hydraulic bladder is actuated by a first actuator and attached with respect to the frictional-engagement member. The first hydraulic bladder when actuated applies pressure to the frictional-engagement member thereby urging the frictional-engagement member into frictional engagement with the disk. The second hydraulic bladder is actuated by a second actuator and attached with respect to the mechanical-engagement member. The second hydraulic bladder when actuated applies pressure to the mechanical-engagement member thereby urging the mechanical-engagement member into mechanical engagement with the disk. It is more preferable when the helical splines spiral in the same direction of rotation of the disk. When the disk is under rotation about the axis, the mechanical-engagement member and the disk will tend to decouple due to centrifugal effect.

It is beneficial to locate an axial spring between the disk and the couple in another version of this aspect of the invention.

In yet another version of this aspect of the invention, the disk has a mechanical-engagement surface. The mechanical-engagement surface has disk-surface discontinuities. Also, the mechanical-engagement member has a disk-engagement surface having mechanical-engagement-member-surface discontinuities which are complementary to the disk-surface discontinuities. The mechanical engagement between the mechanical-engagement member and the disk occurs through interlocking of the disk-surface discontinuities and mechanical-engagement-member-surface discontinuities.

### BRIEF DESCRIPTION OF THE DRAWINGS

The drawings illustrate preferred embodiments which include the above-noted characteristics and features of the invention. The invention will be readily understood from the descriptions and drawings. In the drawings:

FIG. 1 is a component depiction of the prior art.

FIG. 2 is a side sectional view of an embodiment of the invention.

FIG. 3A is a top sectional view of the embodiment depicted in FIG. 2 taken along the reference line 3-3.

FIG. 3B is a top sectional view of the embodiment depicted in FIG. 2 taken along the reference line 3-3 with rotational inertial difference between the flywheel and the frictional-engagement member.

FIG. 4A is an alternate gate-keeping mechanism disengaged.

FIG. 4B is an alternate gate-keeping mechanism frictionally engaged.

FIG. 4C is an alternate gate-keeping mechanism mechanically engaged.

FIG. 5 is a side sectional view of an alternate embodiment of the invention.

FIG. 6 is a is a top sectional view of the embodiment depicted in FIG. 5 taken along the reference line 6-6.

FIG. 7 is a side sectional view of an alternate embodiment of the invention.

FIG. 8 is a side sectional view of an alternate embodiment of the invention depicted in FIG. 7 with the mechanically-engaging portions disengaged.

### DETAILED DESCRIPTIONS OF THE PREFERRED EMBODIMENTS

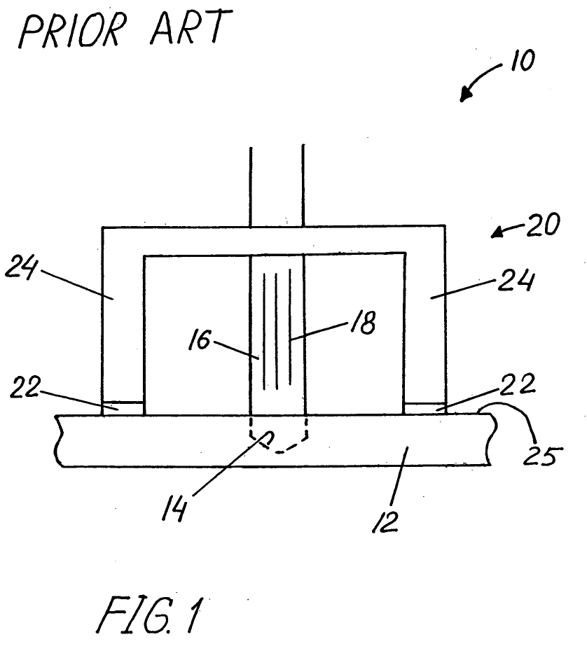

FIG. 1 is a heavy duty clutch of the current art shown in simplified component form. Flywheel 12 is mounted such that it can rotate about its rotational axis of symmetry. Flywheel 12 is attached to and driven by engine (not shown). Within flywheel 12 is pilot bearing indentation 14. Pilot bearing indentation 14 is configured to receive splined input shaft 16. Input shaft 16 has splines 18 longitudinally running along its axial surface.

With the transmission disengaged, driven flywheel 12 rotates freely about input shaft 16 without causing rotation of input shaft 16.

Surrounding input shaft 16 is frictional-engaging member 20. Frictional-engaging member 20 has friction pads 22 spaced about cylindrical cage 24. Frictional-engaging member 20 has a central aperture (not shown) which is splined to be complementary to input shaft splines 18 to allow mating engagement between input shaft 16 and frictional-engagement member 20, which also allows for axial movement of frictional-engagement member 20 along the input shaft 16. To rotate input shaft 16, axial force is applied to frictional-engaging member 20 to force movement along input shaft 16 such that friction pads 22 engage flywheel friction surface 25 located on a transmission side of flywheel 12. Friction pads 22 and flywheel friction surface 25 are designed to have a maximized coefficient static friction. Friction pads 22 and flywheel surface 25 are typically coated with ground stone such as asbestos, or made of ceramic. In operation, energy generated by engine causes rotational motion of flywheel 12. A clutch actuator forces frictional engagement member 20 into contact with flywheel friction surface 25. Immediately prior to initial contact, cage 24 is rotationally idle while flywheel 12 is rotating at high angular velocity. The frictional engagement between rotating flywheel surface 25 and friction pads 22 results in angular acceleration of cage 24. Due to the mechanical connection between splines 18 of input shaft 16 at juncture with cage 24, input shaft 16 is accelerated indirectly by flywheel 12.

Continued operation of the particular vehicle is dependent on maintenance of static-friction engagement between friction pads 22 and flywheel surface 25. Practically, the interface between friction pads 22 and flywheel surface 25 is subject to wear at every non-synchronous engagement of these two component. The initial contact is sliding of one component with respect to another; this initial-contact sliding is one of many factors causing wear of these interactive surfaces.

Moreover, as described above, when under heavy load (for instance at high speeds, carrying heavy load, or going up an incline), the force of the load opposing the rotation of the frictional-engagement member may exceed the coefficient of static friction thereby causing a slippage between friction pad 22 and flywheel friction surface 25. Moreover still, the more worn the interaction surfaces, the more likely slippage will occur on common load or level ground.

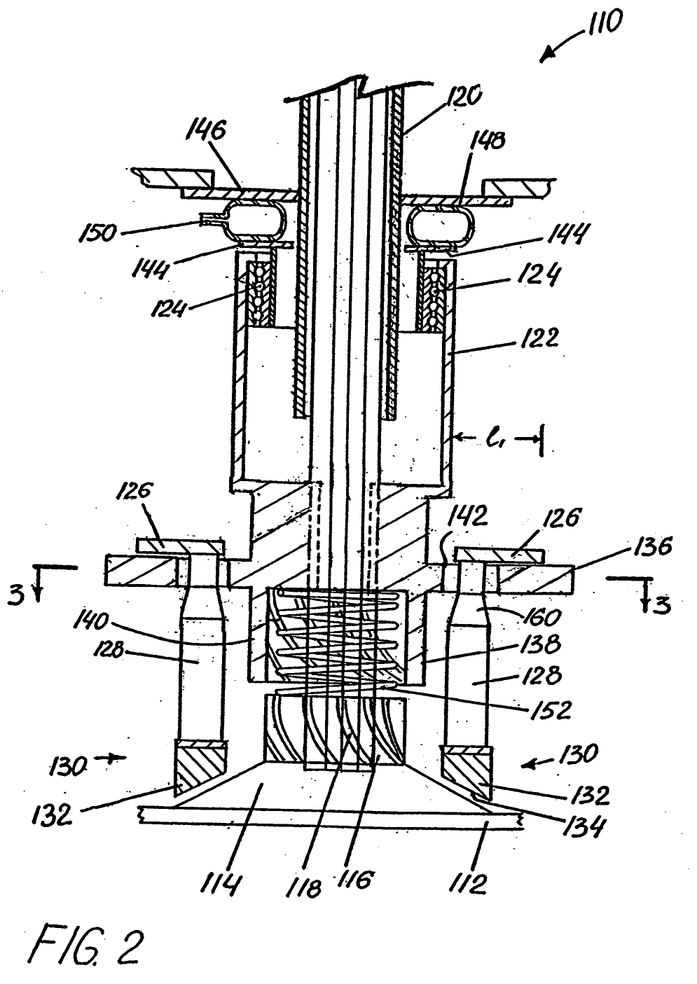

FIG. 2 shows one preferred embodiment of the current invention. In its basic form, axial pressure is applied to the synchronous couple to force a frictionally-engaging portion into frictional engagement with the flywheel. This is similar to the theoretical operations of current clutches. Once the flywheel has accelerated the frictionally-engaging portion of the couple into synchronous speed, the mechanical engagement portion of the couple mechanically engages the flywheel thereafter relying on mechanical engagement rather than frictional engagement for the continuation of the drive. The frictionally-engaging portions may alternately remain in contact or become disconnected during mechanical engagement. Regardless of the status of frictional engagement after mechanical engagement, there will be no slippage between the flywheel and the drive shaft as long as there is mechanical engagement.

For convenience and clarity of illustration, input shafts and pilot bearings have been omitted from the described embodiments. The omission is to provide clarity for the illustrations of the novel invention and is not an indication of the absence of these important components for the operation of the invention; in fact, each of the following embodiments does have an input shaft and pilot bearing identical to the current art. A synchronous couple 110 is illustrated in FIG. 2. Attached and driven by engine (not shown) is flywheel 112. On the transmission side of flywheel 112 is conical frictional acceleration surface 114. Flywheel frictional acceleration surface 114 has a radial symmetry about flywheel 112 and is flat and continuous. Flywheel frictional acceleration surface 114 is most preferably coated or made of ceramic. Extending out from conical flywheel frictional acceleration surface 114 is cylindrical splined hub 116. Cylindrical splined hub 116 is also radially symmetric about the axis of the flywheel. Hub splines 118 extend out radially from hub 116. Splines 118 may run axially along hub 116 or may be helical. Helical hub splines 118 may spiral in the direction of rotation of the rotation of flywheel 112 or in opposition to the rotation of flywheel 112. The separate choices of spiral have different mechanical advantages.

Helical splines spiraled in the same direction relative to the rotational motion of flywheel 112 not only facilitates decoupling, but facilitates coupling as when flywheel 112 is braking, the inertia of the coupling gives the coupling momentary greater speed than the flywheel so that the flywheel seems to go slowly in reverse (relative to the couple) and hence facilitates coupling.

Axially-aligned splines are adaptable for either the single-air-bladder or the two-air-bladder systems described hereafter. Helical splines rotating opposite to the direction of rotation (from the flywheel out toward the drive shaft), are best suited to the one-air-bladder process. In such a helical arrangement, at the inertial difference, as flywheel 112 subject to braking, slightly helical splines will aid in the engagement.

Synchronous couple 110 has cylindrical sleeve 120 which is coaxial with and surrounds input shaft 16 (better seen in FIG. 1). As with the prior art, sleeve 112 has internal splines to mate with input shaft splines 18.

Coaxial with and surrounding sleeve 120 is outer shell 122. Outer shell 122 is capable of free rotation about sleeve 120. To facilitate relative rotation, bearings 124 are interposed. Outer shell 122 has ledge collar 126 extending radially out from shell 122. Integral with ledge collar 126 are four pins 128 spaced equidistant about ledge collar 126. At distal ends 130 are friction pads 132. Friction pads 132 have a friction engaging surface 134 designed to maximize frictional engagement between friction engagement surface 132 and flywheel frictional acceleration surface 114.

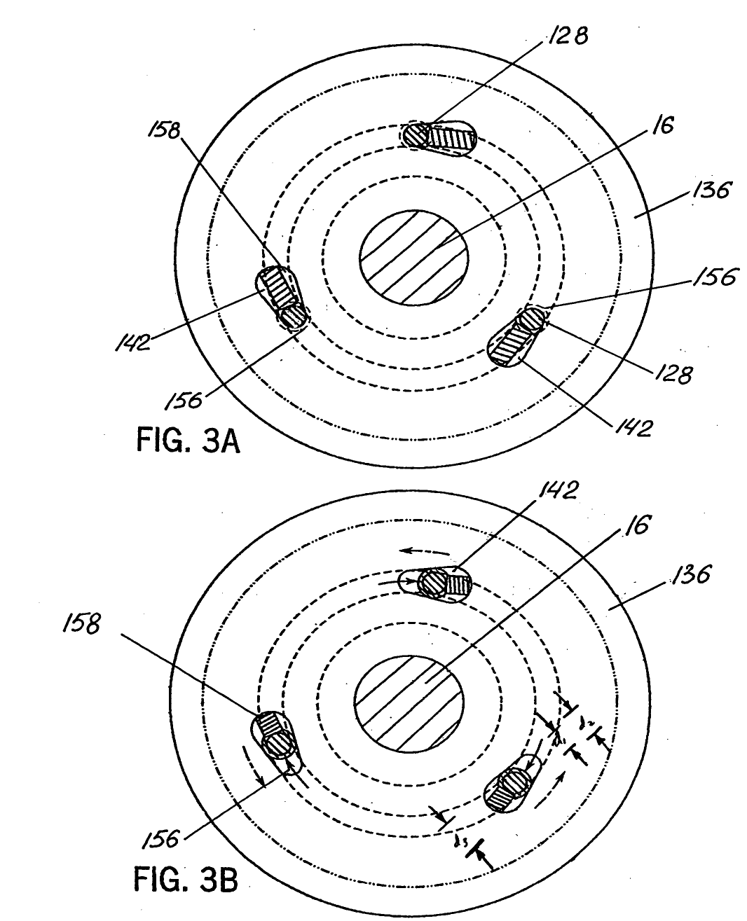

Integral with sleeve 120 extending radially about and integral with sleeve 120 is retention yoke 136. Extending down from retention yoke 136 is female hub port 138. Female hub port 138 is configured to have a cylindrical splined interior 140 complementary to hub 116. Pins 128 extend up through tear-shaped apertures 142 in retention yoke 136 (better seen in FIGS. 3A and 3B). At top of shell 122 is shelf 144. Fixed to vehicle is ceiling 146. Located between shelf 144 and ceiling 146 is air bladder 148. Air bladder 148 is actuated through actuator (not shown) through introduction of air through airline 150. Although described as a pneumatic system, which is preferable as trucks typically are installed with pneumatic systems, it can easily be seen that a liquid hydraulic system would be just as effective. For this reason, in the remainder of this application, applicants have defined the term “hydraulic” broadly to include pneumatic systems. Hub 118 and synchronous couple 110 are linked through spring 152 which is affixed to hub 118 but free wheeling with respect to synchronous couple 110.

Axial force is applied through activation of air bladders 150 to shell 122. For weight, cost, and reliability, air bellows are desirable for applying axial force. Although air bladders are desirable, it is observable that axial force may be applied through a variety of means, specifically including springs. Activation of air bladders 150 through standard actuators (not shown) forces frictional pad surface 134 into engagement with the flywheel friction surface 114. Under load, flywheel 112 is decelerated momentarily. The engine provides greater power to flywheel 112 to accelerate it back up to standard, pre-load RPM. Once pre-load angular velocity is obtained, engine decelerates flywheel 112 to prevent flywheel 112 from further exceeding pre-load angular velocity. It is at this point of deceleration of flywheel 112 that a slight inertial difference occurs between the flywheel 112 and pins 128. The inventors make use of this inertial “catch” to allow for mechanical engagement.

As seen in FIGS. 3A and 3B, a horizontal section of yoke 136 is shown. Pins 128 extend up through aperture 142. When frictional members 134, 114 are disengaged or when frictional members 134, 114 are engaged and at synchronous angular velocities, aperture springs 154 force pins 128 into narrow portion 156 away from bulbous portion 158. Pins 128 have a flare with portions of pins 128 having diameter d₁ and portions of pins 128 having diameter d₂, greater than d₁. Apertures 142 have narrow portions 156 substantially equal in dimension to d₁ but less that d₂, and bulbous portions 158 dimensioned d₃ greater in dimension than d₂. Ledge collar 126 has a diameter dimension l₁, which is larger than d₃ in order to provide a stop. It will be realized that the stop has a dimension greater than the aperture dimensions; when Applicants use the term “diameter” with regard to this stop, it will be realized that such term does not require circularity of the stop as the ledge collar illustrated is not circular with respect to the interaction with aperture.

Each pin 128 has flared portion 160. Flared portions are wider than narrow portion 156 of aperture 142, but narrower than bulbous portion 158. At the inertia difference occasioned by the deceleration of flywheel 112, aperture spring 154 is compressed by pin 128 allowing flared portion 160 to move toward bulbous portion 158. Retention yoke 136 is able to slide down pin 128 and allowing female hub part 138 to mate with hub 116. Flywheel 112 and sleeve 120 are mechanically engaged as they drive input shaft 16.

With synchronicity restored, pins 128 are restored to their relative location within narrow portion 156 of aperture 142 by aperture springs 154.

To disengage, air bladders 150, rotation of flywheel 112 causes decoupling of helical splines 118. Decoupling is assisted by hub spring 152, which had been compressed when air bladder 150 had been actuated.

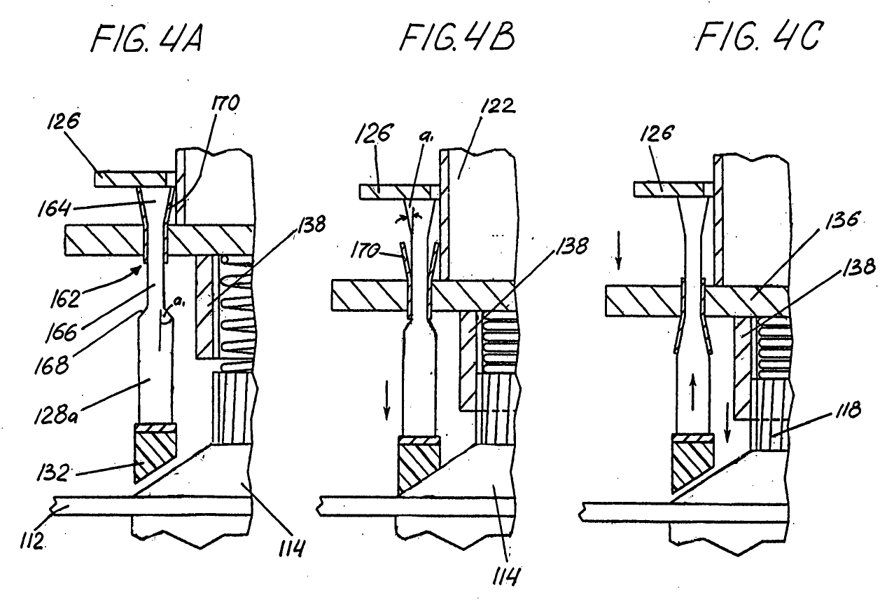

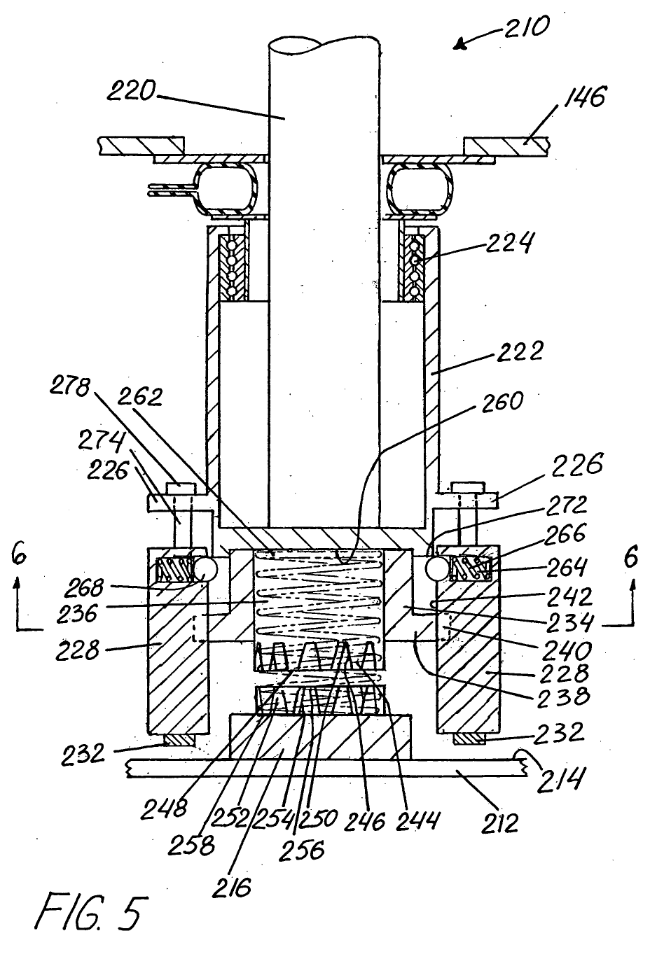

FIGS. 4A-4C show a variation for the gate-keeping accomplished to tear-shaped aperture 142/pin 128 inner action. FIG. 4A shows the couple disengaged, FIG. 4B shows frictional engagement, and FIG. 4C shows mechanical engagement.

Within retention yoke 136 are circular apertures 162. Extending up through circular apertures 162 are pins 128a. Pins 128a are attached at the proximal end 164. Pin 128 has a flanged exterior surface making a first angle A1 with respect to pin access. Adjacent to and distal from proximal end 164 is shaft portion 166. Adjacent to shaft portion 166 and distal thereto is flanged shoulder portion 168. Flanged shoulder portion 168 has an exterior angle with respect to the axis A2 such that A2 is greater than A1. Along length of pin 128a at its most distal end is friction pad 132.

Within circular aperture 162 and between pin 128a and retention yoke 136 are butterflies 170. Butterflies 170 are pieces of high tensile strength metal having a single bend.

In operation, when air bladders 150 are first engaged, axial pressure is translated along outer shell 122 which causes butterflies 170 to engage shoulder 168, thereby forcing friction pad 132 into engagement with flywheel friction surface 114. As additional pressure is provided by air bladder 150, the resistance provided by shoulder to butterflies is overcome allowing retention yoke 136 (and hence female hub part 138) to continue in a distal direction axially and allow mechanical engagement of female hub part 138 with hub 116.

There are many practical means of accomplishing Applicants' invention of accelerating the input shaft through frictional engagement prior to mechanically mating components to allow driving of the input shaft by the flywheel without concern of slippage of frictionally-engaged components.

Seen FIG. 5 is another synchronous couple 210. Flywheel 212 is driven by engine. On transmission side of flywheel is flywheel friction surface 214. Centered on flywheel 212 is cylindrical hub 216. Sleeve 220 surrounds and is integrated with input shaft 16 (seen in FIG. 1). Outer shell 222 is cylindrical and surrounds sleeve 220. Outer shell 222 may freely rotate about sleeve 220. Bearings 224 make motion of outer shell 222 with respect to sleeve 220 more easily accomplished.

Extending radially outward from outer shell 222 are a series of ledged tabs 226.

A frictional engagement member 228 is cylindrical and coaxial with input shaft 16, sleeve 220, and flywheel 212. At the distal end of frictional engagement member 228 are friction pads 232. Friction pads 232 are designed to frictionally engage flywheel friction surface 214 when synchronous couple 210 is initially actuated. Integral with and extending distally from outer shell 222 is toothed drum 234. Toothed drum 234 is cylindrical with a hollow core 236. Toothed drum 234 has shoulder portions 238, which have splined edges 240 to interact with splined interior surface 242 of frictional engagement member 228.

Extending distally from toothed drum 234 are drum teeth 244. Drum teeth 244 have canted sidewalls 246 and horizontal (with respect to the drawing) crests 248 and troughs 250. Drum teeth 244 are configured to be complementary to hub teeth 252, which also have canted hub-teeth sidewalls 254 and horizontal (with respect to the drawing) hub teeth crests 256 and hub teeth troughs 258. As seen, it is preferable to have sidewalls 254 canted to allow for easier ingress and egress into mating. By canting both the leading and trailing edges of teeth 244, teeth 244 will tend to disengage when flywheel 212 is accelerating (driving) or decelerating frictional-engagement member (or alternatively, the frictional-engagement member is driving flywheel 212). To further facilitate engagement, it is desirable to have the intersection of the canted vertical faces and the horizontal face of teeth 244 rounded to remove any impediment to mating.

Extending up from hub 216 to proximal end 260 of core 236 is hub spring 262.

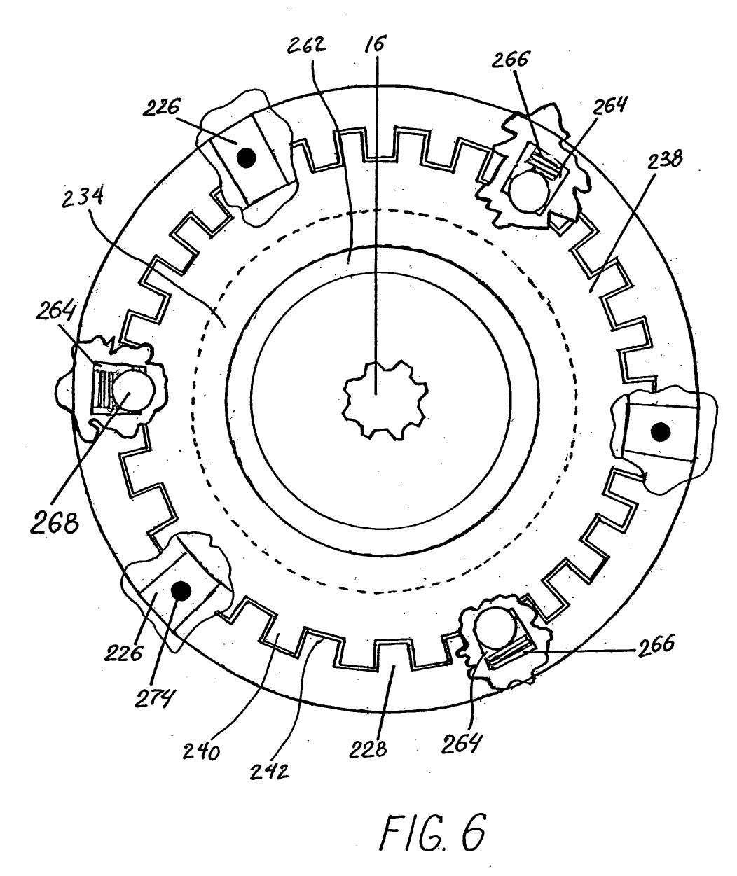

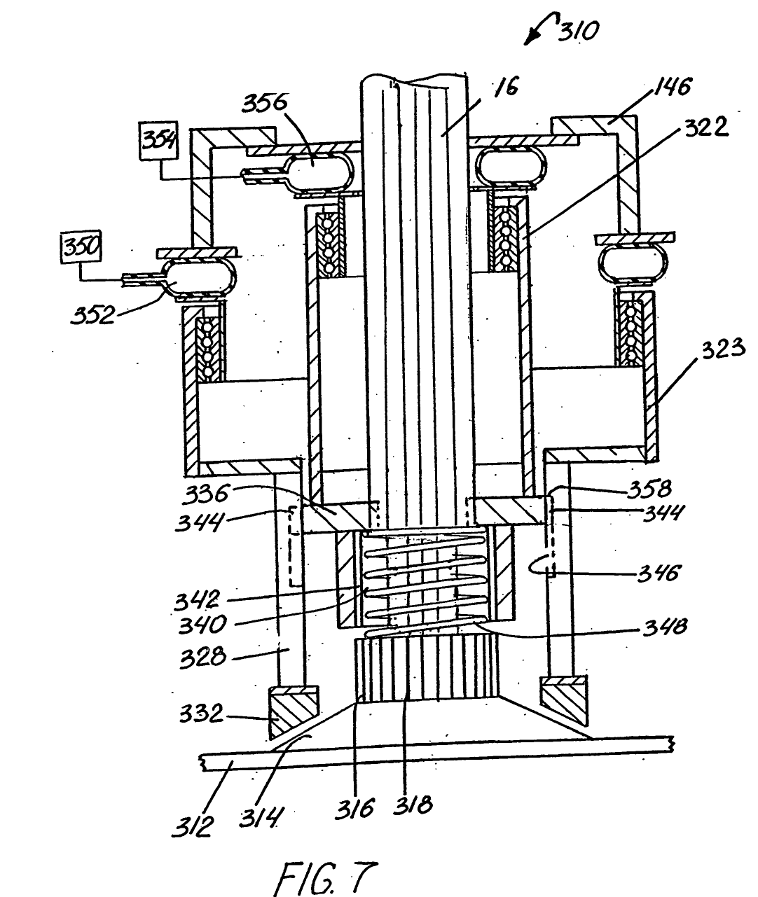

As better seen in FIG. 6, extending into friction engagement member 228 are three ball chambers 264. Within each ball chamber 264 are chamber springs 266. Situated in opening of ball chamber 264 and in contact with chamber spring 266 is gate-keeping ball 268.

In operation, when air bladders 270 are actuated, they are actuated to an initial pressure (for illustration example 60 psi). The air bladder 270 thereby causes axial movement of sleeve 220 and outer shell 222 along input shaft 16. Axial pressure is translated along outer shell 222 to outer shell lower edge 272 which rests on gate-keeping ball 268. Chamber spring 266 is chosen with a predetermined spring tension which is greater than one-third of the initial axial pressure of air bladder 270 (for purposes of this example, greater than 20 psi). Axial pressure of shell is then translated through gate-keeping ball 268 to frictional engagement member 228 causing frictional engagement of friction pad 232 with flywheel friction surface 214.

Air bladder 270 is further actuated to a second, greater pressure (for example 80 psi). Hub spring 262 is further chosen to have a spring constant allowing it to compress at a predetermined pressure less than one-third of the second actuation pressure (for this example, at 25 psi). As greater pressure is exerted on outer shell 222, gate-keeping ball 268 retracts into ball chamber 264 allowing outer shell lower edge 272 to pass distally along inner surface of friction member 242. This motion of outer shell 222 allows for enmeshing of drum teeth with hub teeth. In this manner, input shaft 16 is now driven by flywheel 212 through the mechanical engagement of drum teeth 244 and hub teeth 252.

To disengage the couple, air bladder 270 is bled allowing for hub spring 262 which had been compressed by the actuation of the air bladder 270 to now decompress separating drum teeth 244 from hub teeth 252. Moreover, action of hub spring 262 causes ledge tabs 226 to slide along spindle 274 until ledge-tab upper surface 276 meets spindle stop 278 causing disengaging axial movement of friction engaging member 228 from flywheel 212.

FIG. 7 shows another synchronous couple 310. Synchronous couple 310 has independently actuated frictional engaging members and mechanical engaging members.

Flywheel 312 has flywheel frictional acceleration surface 314 and splined hub 316. Hub 316 has splines 318. Flywheel frictional acceleration surface 314 is flat but inclined.

Sleeve 320 is coaxial with input shaft 16 (not shown). Coaxial with sleeve 320 is outer shell 322 and outer hull 323.

Outer hull 323 is directly attached to cylindrical friction engaging member 328. At the distal end of friction engagement member 328 are friction pads 332.

Ledge 336 joins female hub part 338 to outer shell 322. Female-hub-part interior 340 is hollow with a splined interior surface 342. Splined interior surface 342 is complementary to hub spline 318.

Exterior 344 of ledge 336 is splined. Ledge exterior spline 344 are complementary to a portion of the friction-engaging-member interior surface 346 which is also splined to allow for axial motion of the friction engagement surface with respect to the ledge 336.

Extending up from hub 316 into female-hub interior 340 is hub spring 348.

In operation, a first actuator 350 actuates first air bladder 352. Axial pressure is applied thereby to outer hull 323 directly causing frictional engagement between friction pad 332 and frictional acceleration surface 314. Flywheel 312 drives frictional engagement member 328 and thereby, through splined engagement interface 344/346 drives input shaft 16 into synchronous angular velocity with flywheel.

At the point of synchronicity, second actuator 354 actuates second air bladder 356. Pressure from second air bladder 356 causes axial, distal movement of outer shell 322 thereby compressing spring 348 and forcing mechanical engagement of female-hub interior splines 342 with hub splines 318. At this point, flywheel 314 mechanically drives input shaft 16.

At the point of frictional engagement, first air bladder 352 may be evacuated.

To disengage, air bladder 356 is evacuated allowing spring 348 to decompress. Spring 348 causes proximal axial movement of outer shell 322. As splined ledge outer portion 344 moves proximally along friction engagement portion interior surface 346, it encounters a stop 358 at the proximal end of the splined portion of the interior surface of the frictional engaging member. With ledge 336 engaging stop 358, spring 348 drives outer hull 323 (and hence friction pad 332) out of engagement with frictional acceleration surface 314.

A two bladder system is most advantageously actuated by a four-way, air solenoid valve.

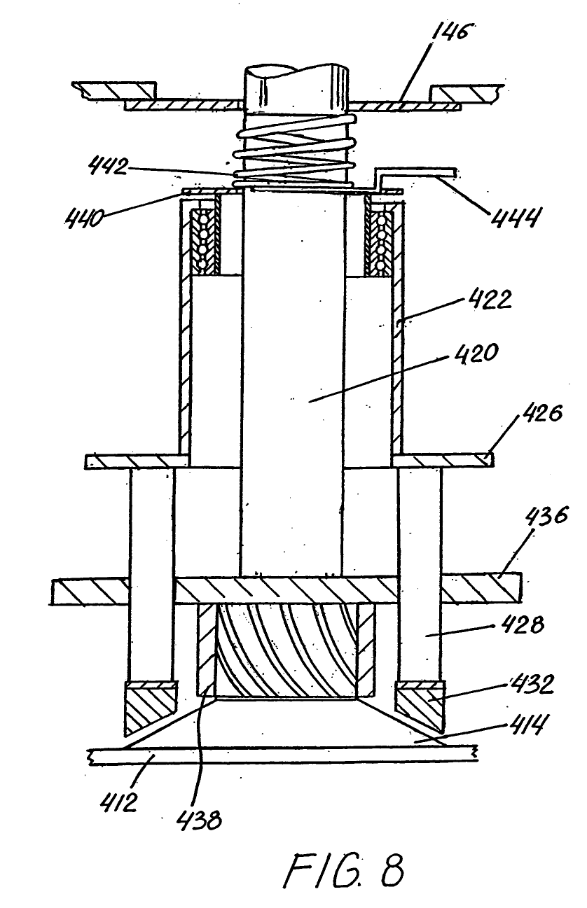

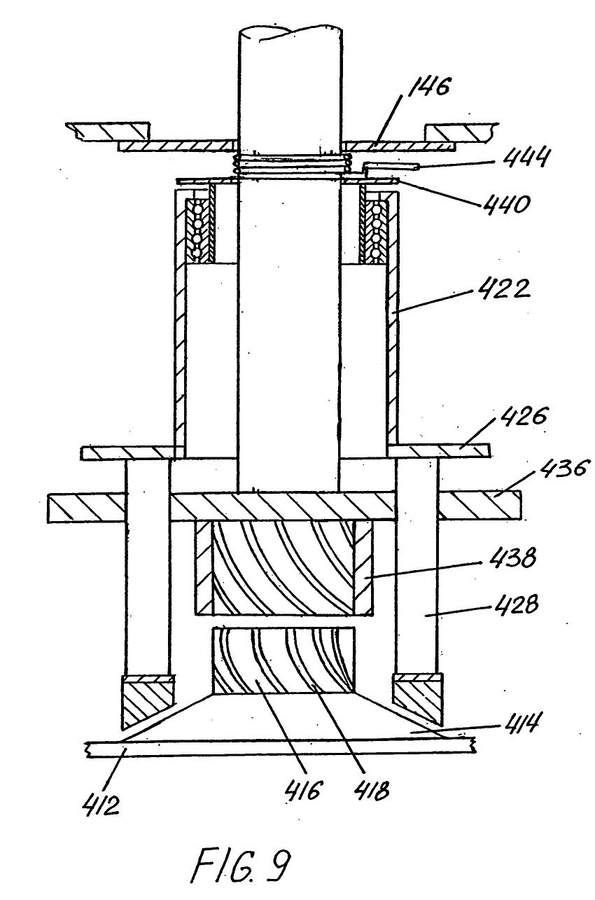

Now turning to FIGS. 8 and 9, an alternate embodiment is depicted. Flywheel 412 has flywheel friction surface 414 and hub 416. Hub 416 has helical splines 418 around its exterior surface.

Surrounding input shaft 16 is sleeve 420. Coaxial with input shaft 16 and sleeve 420 is outer shell 422. Extending radially out from outer shell 422 are ledge tabs 426. Ledge tabs 426 have integrated therewith frictional engagement members 428 which extend distally from ledge tabs 426. At the distal end of frictional engagement member 428 are friction pads 432. Frictional engagement members 428 extend through retention yoke 436. Integral with and extending distally from retention yoke 436 is female hub port member 438 which is cylindrical and coaxial with input shaft 16.

At the proximal end of outer shell 422 is spring shelf 440. Attached to spring shelf 440 and in contact with ceiling 146 is spring 442. Applicants will observe at this time that any mechanism to apply axial pressure including mechanical springs, air bladders, or mechanic devices will be acceptable equivalents in the operation of the invention.

In this embodiment, as seen in FIG. 8 when spring 442 is in its natural uncompressed state, female hub part 438 is in mechanical engagement with hub 416. As seen in FIG. 9, to disengage the mechanically-mated female hub part 438 with the hub 416, a disengaging fork 444 is actuated. Actuation is most typically accomplished through mechanical linkage to a foot pedal in the operating cab. Alternatively, disengaging fork 444 could be actuated through electric or magnetic means. Regardless of the means of actuation, disengaging fork 444 causes compression of spring 442 thereby lifting outer shell 422 and disengaging unit 410 from flywheel 412.

Once disengaged, to re-engage synchronous couple 410 to flywheel 412, the actuator must be released. As the actuator is released, disengaging fork 444 is released from its spring-compressing position to a first stage. At the first stage of releasing, frictional engagement occurs between friction pad 432 and flywheel friction surface 414. Once near synchronous speed is obtained between input shaft 16 and flywheel 412 by means of the frictional engagement, the actuator is fully released, fully decompressing spring 442 and allowing for mechanical engagement of female hub part 438 with hub 416.

While the principles of this invention have been described in connection with specific embodiments, it should be understood clearly that these descriptions are made only by way of example and are not intended to limit the scope of the invention.

We claim:

1. A transmission-input assembly for direct drive engagement with a disk which is driven rotationally around a disk axis, said disk having a substantially flat, radial disk surface with a central, shaft-receiving aperture, the assembly consisting of:
an elongated input shaft having a shaft axis coaxial with the disk axis and having a first end rotatably held in the shaft-receiving aperture; and
a synchronous couple having:
a frictional-engagement member axially, slideably attached with respect to the shaft and radially interlocked with the shaft whereby the shaft and the frictional-engagement member rotate about the shaft axis as a unit, further having a frictional surface configured and arranged to engage the disk surface, whereby slippage between the frictional surface and the disk surface is minimized, thereby producing rotation of the frictional engagement member and the shaft about the shaft axis; and
a mechanical-engagement member axially, slideably attached with respect to the shaft and radially interlocked with the shaft whereby the shaft and the mechanical-engagement member rotate about the shaft axis as a unit further having at least one mating element to matingly engage at least one complementary mating-element-engaging element on the disk whereby mechanical engagement occurs between the mechanical-engagement member and the disk thereby producing rotation of the mechanical-engagement member and shaft about the shaft axis; and
at least one pressure-producing member attached with respect to the frictional engagement member whereby pressure may be applied by the pressure-producing member to the frictional engagement member in order to urge the frictional engagement member along the shaft axis into frictional engagement with disk;
a selector for at least one actuator to engage and disengage the at least one first pressure-producing member in response to a stimulus, and
a synchronous engagement element to axially urge the mechanical-engagement member into mechanical engagement with the disk when the shaft and the disk have a same angular velocity;
whereby before frictional engagement, the disk has a first angular velocity and the shaft has a second angular velocity, and after frictional engagement, the second angular velocity is changed to nearly match the first angular velocity, at which point of synchronicity, mechanical engagement occurs between the mechanical-engagement member and the disk to allow for direct drive through mechanically-coupled rotation.

2. The assembly of claim 1 wherein:
the mating element further comprises at least one axially extending tooth out from the radial disk surface, and
the mating-element-engaging element further comprises at least one axially extending tooth-engagement member.

3. The assembly of claim 2 wherein the at least one tooth has at least one canted, vertical side wall.

4. The assembly of claim 1 wherein:
the mating element further comprises a hub extending axially out from the radial disk surface, with longitudinal hub splines, and
the mating-element-engaging element further comprises a collar extending axially out from the mechanical-engagement member, with longitudinal collar splines complementary to the hub splines of the disk, whereby the mechanical engagement between the mechanical-engagement member and the disk occurs through interlocking of the longitudinal collar splines and the longitudinal hub splines.

5. The assembly of claim 4 where the longitudinal hub splines and the longitudinal collar splines are helical.

6. The assembly of claim 5 wherein the helical splines spiral from the mechanical-engagement member to the disk in the same direction of rotation of the disk whereby when the disk is under rotation about the axis, the mechanical-engagement member and the disk will tend to decouple due to centrifugal force.

7. The assembly of claim 1 wherein the synchronous engagement element is:
a plurality of elongated pins of a certain number attached with respect to the frictional-engagement member, each pin having a proximal end of a first diameter attached with respect to the frictional-engagement member, thence extending distally therefrom, parallel to the axis, and a distal end of a second diameter, said second diameter less than the first diameter with a taper from the distal end to the proximal end, and said distal end terminating in a stop of a third diameter greater than the second diameter; and
a top cap attached with respect to the mechanical-engagement portion, and encircling but not fixedly engaging the shaft, said top cap defining a series of oblong apertures at least equal in number to said pins, each aperture having a bulbous portion dimensioned larger than the first diameter but less than the third diameter and a narrow portion dimensioned greater than the second diameter but less than the first diameter, said bulbous end of each aperture trailing the narrow end when the frictional-engagement portion is in rotational motion; and
a resilient member within the bulbous end of the aperture and in contact with the at least one pin with a restoring force directed toward the narrow end, whereby a pin not under other pressure will be driven relative to the top cap by the restoring force to a position in the narrow portion of the aperture;
whereby when the couple is not rotating and the pressure-producing member is not applying pressure to the frictional-engagement member, the pin extends through the narrow portion of the aperture with the stop distal to the top cap and the taper is within the aperture, and whereby when the frictional-engagement member is under pressure from the pressure-producing member thereby placing the shaft under rotation by engagement of the frictional-engagement member with the disk but the mechanical-engagement member is not engaged, the top cap will rotate with the couple whereby the tapered portion of the pin is forced into the narrow portion of the aperture and further thereby preventing axial movement of the top cap; and whereby when the first angular velocity is exceeded by the second angular velocity, the pins will experience the restoring force and a rotational shear force due to the different angular velocity, said restoring and rotational shear forces pushing the pins toward the bulbous end during which push, the axial force of the pressure-producing member will urge the mechanical-engagement member into synchronous couple.

8. The assembly of claim 7 further comprising an axial spring located between the disk and the couple.

9. The assembly of claim 1 wherein the synchronous engagement element is:
a plurality of elongated pins of a certain number attached with respect to the frictional-engagement member, each pin having a proximal end of a first diameter attached with respect to the frictional-engagement member, thence extending distally therefrom, parallel to the axis, and a distal end of a second diameter, said second diameter less than the first diameter with a taper from the distal end to the proximal end, and said distal end terminating in a stop of a third diameter greater than the second diameter; and
a top cap attached with respect to the mechanical-engagement portion, and encircling but not fixedly engaging the shaft, said top cap defining a series of oblong apertures at least equal in number to said pins, each aperture having a bulbous portion dimensioned larger than the first diameter but less than the third diameter and a narrow portion dimensioned greater than the second diameter but less than the first diameter, said bulbous end of each aperture trailing the narrow end when the frictional-engagement portion is in rotational motion; and
a resilient member within the bulbous end of the aperture and in contact with the at least one pin with a restoring force directed toward the narrow end, whereby a pin not under other pressure will be driven relative to the top cap by the restoring force to a position in the narrow portion of the aperture;
whereby when the couple is not rotating and the pressure-producing member is not applying pressure to the frictional-engagement member, the pin extends through the narrow portion of the aperture with the stop distal to the top cap and the taper is within the aperture, and whereby when the frictional-engagement member is under pressure from the pressure-producing member thereby placing the shaft under rotation by engagement of the frictional-engagement member with the disk but the mechanical-engagement member is not engaged, the top cap will rotate with the couple whereby the tapered portion of the pin is forced into the narrow portion of the aperture and further thereby preventing axial movement of the top cap; and whereby when the first angular velocity equals the second angular velocity, the pins will experience no other angular force other than the restoring force and hence will be pushed towards the bulbous end and the axial force of the pressure producing member will urge the mechanical-engagement member into synchronous couple.

10. The assembly of claim 1 wherein the at least one pressure-producing member is at least one hydraulic bladder.

11. The assembly of claim 10 where the at least one hydraulic bladder is further comprised of:
a first hydraulic bladder actuated by a first actuator and attached with respect to the frictional engagement member whereby the first hydraulic bladder when actuated applies pressure to the frictional-engagement member thereby urging the frictional-engagement member into frictional engagement with the disk;
a second hydraulic bladder actuated by a second actuator and attached with respect to the mechanical-engagement member whereby the second hydraulic bladder when actuated applies pressure to the mechanical-engagement member thereby urging the mechanical-engagement member into mechanical engagement with the disk.

12. The assembly of claim 11 wherein the helical splines spiral in the same direction of rotation of the disk whereby when the disk is under rotation about the axis, the mechanical-engagement member and the disk will tend to decouple due to centripetal force.

13. The assembly of claim 10 further comprising an axial spring located between the disk and the couple.

14. The assembly of claim 1 further comprising:
the disk having a mechanical-engagement surface, said mechanical-engagement surface having disk-surface discontinuities, and
the mechanical-engagement member having a disk-engagement surface having mechanical-engagement-member-surface discontinuities which are complementary to the disk-surface discontinuities, whereby the mechanical engagement between the mechanical-engagement member and the disk occurs through interlocking of the disk-surface discontinuities and mechanical-engagement-member-surface discontinuities.

15. A method for decoupling a rotationally driven member which is axially mechanically coupled to a driving member which is rotating about an axis, the method comprising:
providing a cylindrical driving hub having a proximal end attached to the driving member such that the hub is coaxial with the axis of rotation of the driving member, and a distal end, and having helical, longitudinally-extending hub splines, said hub splines spiraling with respect to the cylinder from the proximal end of the hub to the distal end of the hub in a circular direction opposite the direction of rotation of the driving member;
providing a driven member having a cylindrical driven hub with a proximal end and a distal end, said distal end attached with respect to the driven member and having longitudinally-extending helical splines said splines complimentary in shape and spiral to the driving hub splines in order that the driving hub splines may interact the driven hub splines producing rotational motion in the driven member;
providing an axial pressure member attached with respect to the driven member whereby the axial pressure from the pressure-providing member will urge the driven-hub splines into mechanical engagement with the driving-hub splines;
providing a switch to selectively engage or disengage the pressure-producing member; and
disengaging the pressure-producing member, thereby allowing centrifugal force produced by the rotation of the driving member to force the respective splines of the driving hub and driven hub into disengagement.

16. A method for producing mechanical synchronous coupling of a rotating driving member having a mechanical-engagement receiving member to a rotating driven member having a frictional-engagement member in frictional contact with the rotating driving member, the driving member and the driven member rotating about a common axis, the method consisting of the steps:
providing a mechanical-engagement member rotatably and axially slidably attached with respect to the frictional-engagement member;
applying axial pressure to the mechanical-engagement member through a pressure-producing member configured and arranged to apply axial pressure in the direction of engagement with the driving member;
providing a synchronizer in contact with the mechanical-engagement member, having:
a support member attached with respect to the driving member, defining at least one channel,
at least one pilot member attached with respect to the mechanical-engagement member, configured and arranged to freely travel along the channel and thereby allow axial travel of the mechanical-engagement member toward engagement with the mechanical-engagement receiving member,
a switchable gate-keeping member in contact with the pilot member, preventing free movement of the pilot member within the at least one channel when in an enabled mode, and
an inertial switch to disable the gate-keeping member when a positive inertial difference exists between the driving member and the driven member; and
creating the positive rotational inertial difference between the driving member and the driven member in frictional contact with the driving member by angularly decelerating the driving member after the driven member has been accelerated to near synchronous angular velocity with the driving member;
thereby allowing mechanical coupling between the driving member and the driven member when the inertial difference is obtained.

17. The method of claim 16 wherein:
the at least one pilot member is at least one elongated pin of a certain number, each at least one pin having a proximal end of a first diameter attached with respect to the frictional-engagement member, thence extending distally therefrom, parallel to the axis, and a distal end of a second diameter, said second diameter less than the first diameter with a taper from the distal end to the proximal end, and said distal end terminating in a stop of a third diameter greater than the second diameter;
the support member is a top cap attached with respect to the mechanical-engagement portion, and encircling but not fixedly engaging a shaft attached to and coaxial with the driven member, said top cap defining a series of oblong apertures, serving as at least one channel, at least equal in number to said pins, each aperture having a bulbous portion dimensioned larger than the first diameter but less than the third diameter and a narrow portion serving as a gate-keeping member, dimensioned greater than the second diameter but less than the first diameter, said bulbous end of each aperture leading the narrow end when the frictional-engagement portion is in rotational motion; and
the inertial switch is a resilient member within the bulbous end of the aperture and in contact with the at least one pin with a restoring force directed toward the narrow end, whereby the at least one pin not under other pressure will be driven relative to the top cap by the restoring force to a position in the narrow portion of the aperture.

18. The method of claim 17 wherein the resilient member is a metal spring.

19. The method of claim 17 wherein the pressure-producing member is a hydraulic bladder actuated by an actuator.

20. A method for selectively coupling and decoupling in a transmission-input assembly for direct drive engagement with a disk which is driven rotationally around a disk axis, said disk having a substantially flat, radial disk surface with a central, shaft-receiving aperture, the method consisting of:
providing the transmission-input assembly having
an elongated input shaft having a shaft axis coaxial with the disk axis and having a first end rotatably held in the shaft-receiving aperture;
a synchronous couple having:
a frictional-engagement member axially, slideably attached with respect to the shaft and radially interlocked with the shaft whereby the shaft and the frictional-engagement member rotate about the shaft axis as a unit, further having a frictional surface configured and arranged to engage the disk surface, whereby slippage between the frictional surface and the disk surface is minimized, thereby producing rotation of the frictional engagement member and the shaft about the shaft axis;
a mechanical-engagement member axially, slideably attached with respect to the shaft and radially interlocked with the shaft whereby the shaft and the mechanical-engagement member rotate about the shaft axis as a unit further having at least one mating element to matingly engage at least one complementary mating-element-engaging element on the disk whereby mechanical engagement occurs between the mechanical-engagement member and the disk thereby producing rotation of the mechanical-engagement member and shaft about the shaft axis;
at least one pressure-producing member attached with respect to the frictional engagement member whereby pressure of a first value may be applied by the pressure- producing member to the frictional engagement member in order to urge the frictional engagement member along the shaft axis into frictional engagement with disk;
a selector for at least one actuator to engage and disengage the at least one first pressure-producing member in response to a stimulus;
a synchronous engagement element to axially urge the mechanical-engagement member into mechanical engagement with the disk when the shaft and the disk have a same angular velocity;
a releasable gate to selectively prevent axial motion of the mechanical-engagement member; and
an inertial switch triggered by the application of a torque applied by the mechanical-engagement member to release the gate thereby allowing axial motion of the mechanical-engagement member; and
a decoupler attached with respect to the disk providing pressure along the shaft of a second value less than the pressure of the first value exerted by the pressure-producing member, but of a sufficient pressure to eject the synchronous couple from mechanical and frictional engagement with the disk when the pressure-producing member is disengaged;
accelerating the disk;
applying an engaging stimulus to the selector to engage the pressure-producing member and urge the friction-engagement member into frictional engagement with the rotating disk, thereby accelerating the shaft; and
producing an inertial difference between the disk and the shaft; whereby the inertial switch is thrown because of the relative torque due to the inertial difference, thereby releasing the mechanical-engagement member to be urged axially by the pressure from the pressure-producing member, into mechanical engagement with the disk to allow for direct drive through mechanically coupled rotation;
providing a disengaging stimulus to the selector to disengage the pressure-producing member, thereby allowing the decoupler to decouple the synchronous couple from engagement with the disk.

21. The method of claim 20 wherein:
the mating element further comprises a hub extending axially out from the radial disk surface, with longitudinal hub splines, and
the mating-element-engaging element further comprises a collar extending axially out from the mechanical-engagement member, with longitudinal collar splines complementary to the hub splines of the disk, whereby the mechanical engagement between the mechanical-engagement member and the disk occurs through interlocking of the longitudinal collar splines and the longitudinal hub splines.

22. The method of claim 21 where the longitudinal hub splines and the longitudinal collar splines are helical.

23. The method of claim 22 wherein the decoupler is the helical splines which spiral from the mechanical-engagement member to the disk in the same direction of rotation of the disk whereby when the disk is under rotation about the axis without axial pressure being applied with respect to the mechanical-engagement member, centrifugal force will tend to decouple the mechanical-engagement member and the disk.

24. The method of claim 23 wherein the synchronous engagement element is:
a plurality of elongated pins of a certain number, each pin having a proximal end of a first diameter attached with respect to the frictional-engagement member, thence extending distally therefrom, parallel to the axis, and a distal end of a second diameter, said second diameter less than the first diameter with a taper from the distal end to the proximal end, and said distal end terminating in a stop of a third diameter greater than the second diameter; and
a top cap attached with respect to the mechanical-engagement portion, and encircling but not fixedly engaging the shaft, said top cap defining a series of oblong apertures at least equal in number to said pins, each aperture having a bulbous portion dimensioned larger than the first diameter but less than the third diameter and a narrow portion dimensioned greater than the second diameter but less than the first diameter, said bulbous end of each aperture leading the narrow end when the frictional-engagement portion is in rotational motion; and
a resilient member within the bulbous end of the aperture and in contact with the at least one pin with a restoring force directed toward the narrow end, whereby a pin not under other pressure will be driven relative to the top cap by the restoring force to a position in the narrow portion of the aperture;
whereby when the couple is not rotating and the pressure-producing member is not applying pressure to the frictional-engagement member, the pin extends through the narrow portion of the aperture with the stop distal to the top cap and the taper is within the aperture, and whereby when the frictional-engagement member is under pressure from the pressure-producing member thereby placing the shaft under rotation by engagement of the frictional-engagement member with the disk but the mechanical-engagement member is not engaged, the top cap will rotate with the couple thereby forcing the tapered portion of the pin into the narrow portion of the aperture and further thereby preventing axial movement of the top cap; and whereby when the first angular velocity is exceeded by the second angular velocity, the pins will experience no other angular force other than the restoring force and hence will be pushed into the bulbous end and the axial force of the pressure producing member will urge the mechanical-engagement member into synchronous couple.

25. The method of claim 24 further comprising an axial spring located between the disk and the couple.

26. The method of claim 21 wherein the at least one pressure-producing member is at least one hydraulic bladder.

27. The method of claim 26 where the at least one hydraulic bladder is further comprised of:
a first hydraulic bladder actuated by a first actuator and attached with respect to the frictional-engagement member whereby the first hydraulic bladder when actuated applies pressure to the frictional-engagement member thereby urging the frictional-engagement member into frictional engagement with the disk; and
a second hydraulic bladder actuated by a second actuator and attached with respect to the mechanical-engagement member whereby the second hydraulic bladder when actuated applies pressure to the mechanical-engagement member thereby urging the mechanical-engagement member into mechanical engagement with the disk.

28. The method of claim 27 wherein the helical splines spiral in the same direction of rotation of the disk whereby when the disk is under rotation about the axis, the mechanical-engagement member and the disk will tend to decouple due to centrifugal force.

29. The method of claim 26 further comprising an axial spring located between the disk and the couple.

30. The method of claim 20 further comprising:
the disk having a mechanical-engagement surface, said mechanical-engagement surface having disk-surface discontinuities, and
the mechanical-engagement member having a disk-engagement surface having mechanical-engagement-member-surface discontinuities which are complementary to the disk-surface discontinuities, whereby the mechanical engagement between the mechanical-engagement member and the disk occurs through interlocking of the disk-surface discontinuities and mechanical-engagement-member-surface discontinuities.
